(19) United States
(12) Patent Application Publication
(10) Pub. No.: US 2026/0364702 A1
(43) Pub. Date: Nov. 19, 2026

(54) INVERTER TYPE PROPORTIONAL CONTROL MICRO WELDING MACHINE

(71) Applicant: NATIONAL SYSTEM CO., LTD., Busan (KR)

(72) Inventor: Byeong Heon KIM, Busan (KR)

(21) Appl. No.: 19/515,532

(22) PCT Filed: May 29, 2024
(86) PCT No.: PCT/KR2024/007288

§ 371 Date: Mar. 2, 2026

(30) Foreign Application Priority Data
Aug. 30, 2023 (KR) 10-2023-0114585

(51) Int. Cl. B23K 9/067; B23K 9/095; B23K 9/10

(52) U.S. Cl. CPC B23K 9/0673; B23K 9/0953; B23K 9/1062

(57) ABSTRACT

An inverter-type proportional-control micro welding apparatus includes: a main body; a welding torch connected to the main body and provided therein with an electrode; a welding electrode connected to the main body and connected to a material to be welded; and a current supply unit installed in the main body and configured to apply a current for welding to the electrode of the welding torch and the welding electrode. The current supply unit includes: a power input unit, a first rectifying unit, a smoothing unit, an inverter unit, a transformer unit, a second rectifying unit; an output terminal connected to the electrode of the welding torch and the welding electrode to output a (+) output and a (−) output, and a control unit configured to control an overall operation of the current supply unit and perform hot-start and anti-stuck through a proportional controller.

### TECHNICAL FIELD

The present invention relates to an inverter-type proportional-control micro welding apparatus, and more specifically, to an inverter-type proportional-control micro welding apparatus capable of performing hot-start adjustment and anti-stuck while performing proportional control such that an error, which is defined as a tracking error based on a difference between an output current and a target current, converges to zero (0).

### BACKGROUND ART

The welding technology used in all industrial fields requires the supply of stable power at low voltage and high current to an electrode rode and base material in order to smoothly generate an arc and improve the welding quality, which is the objective of welding.

Accordingly, with the development of power electronics technology to supply stable power, alternating current (AC) arc welding machines, thyristor welding machines, and inverter welding machines have been developed in that order.

Although thyristor welding machines have been widely used in the past, the size thereof is being gradually decreased due to the appearance of inverter welding machines.

This trend is because the welding quality of the inverter is excellent and the welding machine may be lightweight.

Despite these advantages, the control technology of the inverter is still insufficient and has many problems.

Inverter technology trends in welding machines are as follows.

For example, in TIG welding machines, a high frequency generator is used for arc start.

A method is used in which a space between a tungsten electrode and a base material is subjected to dielectric breakdown, and then a welding current is rapidly increased using an inverter.

In CO2 welding machines, the voltage and the current change at the same time as the resistance of the welding specimen changes during welding.

However, in the case of conventional inverters, due to a constant-current control scheme, Joule heat varies during welding as a result of changes in resistance, and consequently, variations in heat input cause the molten pool of the base material to splash significantly, thereby generating spatter.

In order to solve this problem, there is a trend of introducing an inverter of a constant power control method. That is, the constant power control method maintains a constant current density according to the change in resistance because the voltage and the current are inversely proportional.

Such a constant power control method is mainly applied to expensive welding machines, and is not applied to DC-arc welding machines, which are relatively inexpensive and have a high penetration rate, due to cost issues.

In the case of Brown gas generators, a system is configured simply by directly applying the inverter of the welding machine.

The reality is that electrolysis tanks are installed on output terminals of welding systems instead of welding rods and base materials, without any relevant expertise.

Because the Brown gas generators have been manufactured in such a rough and tumble manner, there is not even any related literature.

### SUMMARY OF THE INVENTION

The present invention has been made in an effort to solve the above problems, and an object of the present invention is to provide an inverter-type proportional-control micro welding apparatus for performing hot-start adjustment and anti-stuck while performing proportional control such that an error, which is defined as a tracking error based on a difference between an output current and a target current, converges to zero (0).

To achieve the above object, an inverter-type proportional-control micro welding apparatus according to one embodiment of the present invention includes: a main body; a welding torch connected to the main body and provided therein with an electrode; a welding electrode connected to the main body and connected to a material to be welded; and a current supply unit installed in the main body and configured to apply a current for welding to the electrode of the welding torch and the welding electrode.

In addition, the current supply unit includes: a power input unit connected to a commercial alternating current, a first rectifying unit configured to rectify the alternating current input from the power input unit into a direct current, a smoothing unit configured to smooth the direct current output from the first rectifying unit, an inverter unit configured to convert the direct current smoothed by the smoothing unit into a variable high-frequency alternating current, a transformer unit configured to transform the alternating current output from the inverter unit into a low-voltage high current suitable for welding, a second rectifying unit configured to re-rectify the alternating current output from the transformer unit to convert the rectified current into a direct current voltage; an output terminal connected to the electrode of the welding torch and the welding electrode to output a (+) output and a (−) output, and a control unit configured to control an overall operation of the current supply unit and perform hot-start and anti-stuck through a proportional controller.

According to the present invention, a hot-start function is provided to facilitate arc generation when welding is started, thereby facilitating welding not only for experts but also for general users.

In addition, an anti-stuck function is implemented to prevent a short circuit between the base material and the welding rod that may occur during the welding process, thereby increasing the ease of work.

In addition, the inverter-type welding apparatus proposed by the present invention has the advantages of improving welding quality by controlling welding output current, reducing welding costs, and increasing welding productivity, thereby contributing to the welding industry a lot.

### BRIEF DESCRIPTION OF DRAWINGS

FIG. 1 is a perspective view showing an inverter-type proportional-control micro welding apparatus according to one embodiment of the present invention.

FIG. 2 is circuit configuration view showing a current supply unit according to one embodiment of the present invention.

FIG. 3 is an exemplary time chart for an insulated gate bipolar transistor (IGBT) of the configuration of the current supply unit according to one embodiment of the present invention.

FIGS. 4 to 15 are a graph, a flowchart, and the like for explaining the inverter-type proportional-control micro welding apparatus according to one embodiment of the present invention.

### DETAILED DESCRIPTION OF THE INVENTION

Since the present invention may make various changes and have various embodiments, specific embodiments will be illustrated in the drawings and described in detail in the detailed description.

However, this is not intended to limit the present invention to specific embodiments, and it should be understood that the present invention includes all modifications, equivalents, and substitutes included in the technical spirit and technical scope of the present invention.

It will be understood that when an element is referred to as being “connected” or “coupled” to another element, it may be directly connected or coupled to the other element or intervening elements may be present.

In contrast, when an element is referred to as being “directly connected” or “directly coupled” to another element, it should be understood that intervening elements may be present.

The terms used herein are only for the purpose of describing particular embodiments and are not intended to limit the present disclosure. The singular expression also includes the plural meaning as long as it does not differently mean in the context.

In the present specification, the term such as “include” or “have” in various embodiments of the present specification is intended to designate the presence of stated features, numbers, steps, operations, components, parts, or combinations thereof, but does not preclude the presence or addition of one or more other features, numbers, steps, operations, components, parts, or combinations thereof.

The terms including an ordinal number such as “first” or “second’ may be used for the names of various components, not limiting the components. The above terms are used merely for the purpose of distinguishing one component from another component.

In addition, the terms “ . . . unit” and the like used herein indicate a unit for processing at least one function or operation, which may be implemented by hardware, software, or a combination thereof.

In addition, the components of the embodiments described with reference to each drawing are not limited to the corresponding embodiments, and may be implemented to be included in other embodiments within a range in which the technical spirit of the present invention is maintained, and it is natural that even if a separate description is omitted, a plurality of embodiments may be implemented again as one integrated embodiment.

In addition, in the description with reference to the accompanying drawings, like reference numerals refer to like or related components regardless of reference numerals, and redundant descriptions thereof will be omitted.

In describing the present invention, a detailed description of related known technologies incorporated herein will be omitted when it is determined that the detailed description thereof may unnecessarily obscure the subject matter of the present invention.

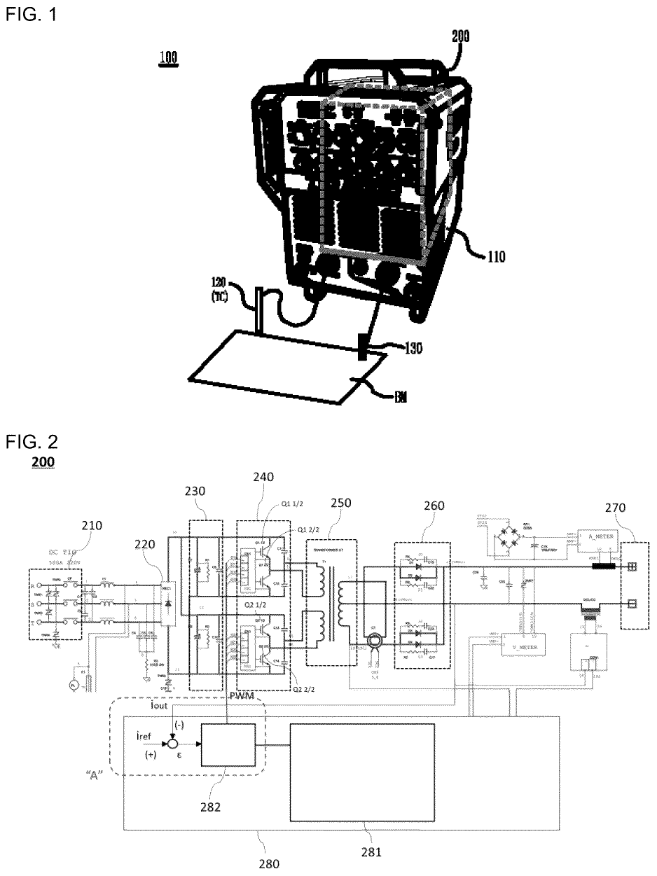

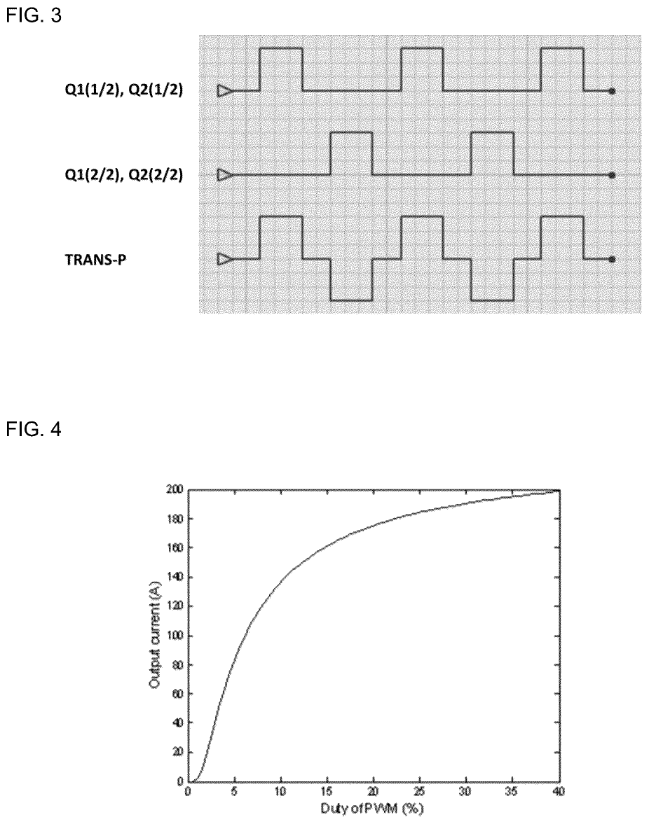

FIG. 1 is a perspective view showing an inverter-type proportional-control micro welding apparatus according to one embodiment of the present invention, FIG. 2 is circuit configuration view showing a current supply unit according to one embodiment of the present invention, FIG. 3 is an exemplary time chart for an insulated gate bipolar transistor (IGBT) of the configuration of the current supply unit according to one embodiment of the present invention, and FIGS. 4 to 15 are a graph, a flowchart, and the like for explaining the inverter-type proportional-control micro welding apparatus according to one embodiment of the present invention.

Referring to the drawings described above, an inverter-type proportional-control micro welding apparatus 100 according to embodiments of the present invention includes: a main body 110; a welding torch 120 connected to the main body 110 and provided therein with an electrode; a welding electrode 130 connected to the main body 110 and connected to a material to be welded BM; and a current supply unit 200 installed in the main body 110 and configured to apply a current for welding to the electrode of the welding torch 120 and the welding electrode 130.

In addition, the current supply unit 200 includes a power input unit 210 connected to a commercial alternating current from the outside, a first rectifying unit 220 configured to rectify the alternating current input from the power input unit 210 into a direct current, a smoothing unit 230 configured to smooth the direct current output from the first rectifying unit 220, an inverter unit 240 configured to convert the direct current smoothed by the smoothing unit 230 into a variable high-frequency alternating current, a transformer unit 250 configured to transform the alternating current output from the inverter unit 240 into a low-voltage high current suitable for welding, a second rectifying unit 260 configured to re-rectify the alternating current output from the transformer unit 250 to convert the rectified current into a direct current voltage, an output terminal 270 connected to the electrode of the welding torch 120 and the welding electrode 130 to output a (+) output and a (−) output, and a control unit 280 configured to control an overall operation of the current supply unit 200 and perform hot-start and anti-stuck through a proportional controller 282.

In addition, the control unit 280 derives an output current iₒᵤₜ in association with a control signal of a microprocessor 281 through the following Equations (1), (2), and (3).

$${i}_{out} = 225 {e}^{[ \frac{5}{{P}_{w}} ]} \qquad Equation ( 1 )$$

$${P}_{w} = \frac{1}{25.6} u \qquad Equation ( 2 )$$

$${i}_{out} = 225 {e}^{( \frac{- 128}{u} )} \qquad Equation ( 3 )$$

(where iₒᵤₜ is an output current, e is a natural constant or Euler's number, u is a control signal, and P_{w} is a PWM duty ratio (%), and 0≤P_{w}≤0.4.)

In addition,
when a tracking error ε is i_{ref}−iₒᵤₜ, the proportional controller 282 satisfies the Equation

$$u = {K}_{p} ε + {K}_{I} ( \frac{1}{{T}_{i}} {\int }_{0}^{{T}_{i}} ε dt ) .$$

(where i_{ref} is a target current, iₒᵤₜ is an output current, u is a control signal, Ti is an integration time sec, Kₚ is a proportional gain A⁻¹, and K_{I} is an integral gain A⁻¹.)

In addition, the i_{ref} corresponds to a target current of the hot-start or anti-stuck.

In addition, the inverter unit 240 measures a voltage and a current, and operates the proportional controller 282 to follow a set current and a set voltage when the measured current and voltage are different from set values.

In addition, in order to facilitate arc formation, when the control unit 280 performs a hot-start function, the following Equation is satisfied such that a current higher than a set welding output current is instantaneously generated by 0 to 50 A according to a value of a hot-start adjustment volume (%).

i_{Hot_start ref}=i_{setting}+50×Hot-start adjustment volume×e^{-2t}^{_{h−t}}

(where, i_{Hot_start ref} is a target welding current to which the hot-start function is provided at the time of starting welding, i_{setting} is a set welding current determined by a user, and tₕ₋ₜ is a time from a time when the hot-start function is performed.)

In addition, when the control unit 280 performs an anti-stuck function, the following Equation is satisfied such that a voltage between the welding torch 120 and the material to be welded BM is measured in real time and a current is increased by 15 A compared to the welding output current at a time when the welding output voltage drops in case where the voltage drops to or below a reference voltage (Vmin).

i_{stuck_ref}=i_{setting}+15×e^{t}^{_{As}}

(where, i_{stuck_ref} is a target welding output current when the anti-stuck function is performed, and the set welding output current is 140 A.)

In the present invention, first, a PI controller is applied such that an error is zero (0) by using a difference between the output current and the target current as the tracking error.

A control system developed to implement such a controller is based on a microcontroller for implementing current control and various functions.

A signal input through a current measurement sensor is compared with the target current to detect an error, so that the output current is controlled using the error.

Second, various functions according to the user's demand are implemented in the welding machine.

In the case of the welding machine, the hot-start function is provided to facilitate arc generation at the start of welding.

Such a function assists start of welding by starting welding at a current approximately 0 to 40 A higher than the target current at the start of welding, thereby enabling welding to start more easily compared to the conventional welding machines.

In addition, the anti-stuck function is provided.

Such a function is a function of measuring a voltage between a base material and a welding rod during welding, and instantly increasing a welding current of 15 amperes A when a distance between the base material and the welding rod approaches, thereby preventing a short circuit between the base material and the welding rod.

As in the case of such a system, the application of the microprocessor makes it possible to implement various functions at the same cost as the conventional systems and achieve high precision.

Next, the configuration and operation of the inverter-type proportional-control micro welding apparatus 100 according to one embodiment of the present invention will be described in detail as follows.

FIG. 1 is an overall structure diagram of an inverter-type proportional-control micro welding apparatus according to one embodiment of the present invention.

The inverter-type proportional-control micro welding apparatus 100 according to one embodiment of the present invention is an apparatus for welding a material to be welded by providing a high current between the electrode of the welding torch 120 and the welding electrode 130 to melt a welding rod (not shown).

As shown in FIG. 1, the inverter-type proportional-control micro welding apparatus 100 proposed by the present invention includes: a main body 110; a welding torch 120 connected to the main body 110 and provided therein with an electrode; a welding electrode 130 connected to the main body 110 and connected to a material to be welded; and a current supply unit 200 installed in the main body 110 and configured to apply a current for welding to the electrode of the welding torch 120 and the welding electrode 130.

In this case, the main body 110 forms a body frame of the welding apparatus 100 according to one embodiment of the present invention, and forms an installation frame of the electrode of the welding torch 120, and the welding electrode 130.

The welding torch 120 is electrically and fixedly connected to a front lower side of the main body 110.

The electrode is provided in the welding torch 120, in which the electrode of the welding torch 120 forms a welding electrode for welding the material to be welded together with the welding electrode 130, and may form the welding rod by itself, or may be formed separately from the welding rod.

The welding torch 130 is electrically connected to the front lower side of the main body 110.

The welding electrode 130 makes contact with the material to be welded to allow a welding current to flow through the material to be welded, and is formed at an end thereof with a connection member in the form of a clamp or a fastening plate.

Since the main body 110, the welding torch 120, and the welding electrode 130 are the same as or similar to those of general welding machines, a detailed description thereof will be omitted in the present invention.

In addition, the inverter-type current supply unit 200 is installed in the main body 110 to apply the welding current.

FIG. 2 is a circuit diagram of the inverter-type current supply unit 200 serving to receive a current of the inverter-type current supply unit 200 to apply a current for welding to the electrode of the welding torch 120 and the welding electrode 130.

As shown in FIG. 2, the inverter-type current supply unit 200 includes a power input unit 210 configured to supply an alternating current (AC), a first rectifying unit 220 configured to rectify the alternating current input from the power input unit 210 into a direct current, a smoothing unit 230 configured to smooth the direct current output from the first rectifying unit 220, an inverter unit 240 configured to convert the direct current smoothed by the smoothing unit 230 into a variable high-frequency alternating current, a transformer unit 250 configured to transform the alternating current output from the inverter unit 240 into a low-voltage high current suitable for welding, a second rectifying unit 260 configured to re-rectify the alternating current output from the transformer unit 250 to convert the rectified current into a direct current voltage, an output terminal 270 connected to a base material BM and a welding torch TC to output a (+) output and a (−) output, and a control unit 280 configured to control an overall operation of the inverter-type current supply unit 200.

The power input unit 210 is connected to a wiring line to receive a general commercial alternating current (AC) and inputs a commercial power (AC) of 380 V or 220 V at 60 Hz.

The first rectifying unit 220 receives the commercial power (AC) of 380 V or 220 V at 60 Hz input from the power input unit 210 to generate a direct current in order to convert the received commercial power using an inverter, and rectifies the alternating current input in three phases into the direct current.

The first rectifying unit 220 employs a full-wave rectification method in which, since a diode allows a current to flow only in one direction from a positive electrode (+) to a negative electrode (−), such a characteristic is utilized so that only a (+) side potential of the alternating current passes, while an opposing potential is pulled toward a (+) side by a diode connected on the other side.

In the first rectifying unit 220, a waveform concentrated on only the (+) side is referred to as a pulsating flow, and a direct current may be obtained when a condenser for smoothing the pulsating flow is connected.

In addition, the first rectifying unit 220 may be formed as a full-wave rectification bridge circuit including four diodes according to the embodiment.

The smoothing unit 230 may be implemented as a smoothing condenser connected to an output unit of the first rectifying unit 220 in order to rectify or detect the pulsating current output from the first rectifying unit 220 and output the direct current.

The inverter unit 240 converts the direct current smoothed by the smoothing unit 230 into a variable high-frequency alternating current, and may generate an alternating current converted into a high frequency of at least 20 kHz or more.

That is, the inverter unit 240 converts the alternating current into a high-frequency AC voltage, and then applies the high-frequency AC voltage to a primary side of the transformer unit 250.

In addition, the inverter unit 240 may be implemented in the form in which four insulated gate-type bipolar transistors (IGBTs) are arranged in a full bridge form to convert the direct current smoothed by the smoothing unit 240 into a variable high-frequency alternating current through cross switching.

The inverter unit 240 performs a switching process of obtaining the alternating current from the direct current using a time chart as follows.

As shown in FIG. 3, the full bridge-type switching circuit is configured such that Q1(1/2) and Q2(1/2) are simultaneously driven and Q1(2/2) and Q2(2/2) are simultaneously driven.

A current flow direction is changed and an AC output voltage is obtained by a time when the IGBT is turned on, and a turn-on time of each IGBT is adjusted, thereby changing a magnitude of the output voltage. Such a method is pulse width modulation (PWM).

In particular, the inverter unit 240 may be controlled in a rapid response system within a very short time using a digital signal processor (DSP) that is one-dimensionally advanced from the conventional control method of the PLC concept, so that the welding heat input to the material to be welded may be minimized and maintained uniformly, thereby allowing a thin plate to be welded safely while controlling deformation and preventing burn-through.

The inverter unit 240 integrally designs a digital processing system that enables control up to 1 ms ( 1/1000 sec), thereby enabling low-strain precision welding of ultra-thin plate welding by the operation of a precision automatic control system even when manual welding is performed as well as automatic welding, and the welding arc is stable in a pulse welding mode and may effectively control penetration and heat distribution by changing the speed of high current and low current.

The inverter unit 240 developed in the present invention performs current control, and thus receives current feedback.

Therefore, in order to measure the current, a Hall sensor is used to measure the current.

A Hall current transformer (CT) has the advantage of a constant system since a circuit is separated from a power side like a conventional hall device, the advantage of performing measurement like a differential voltage circuit using a resistor, and the advantage of a high frequency of a current that may be measured, and since measurement of an alternating current, a direct current, a pulsating current, and the like is possible in various ways, the Hall sensor is selected.

Meanwhile, the IGBT is a type of power semiconductor for high-power switching.

A switching function that blocks or allows electricity to flow may be implemented with other components or circuits, but products that require precise operation require dedicated components that have a faster operation speed and less power loss.

The IGBT is a power switching semiconductor that complements the disadvantages of the conventional switching semiconductor transistors, which are inexpensive but have a complicated circuit configuration and a slow operating speed, and the expensive MOSFET instead of low power and fast speed, and combines only the advantages.

The transformer unit 250, which outputs a voltage to a secondary side and applies the voltage to the second rectifying unit 260, may be implemented as an alternating current transformer that transforms an alternating current into a low voltage and a high current suitable for welding using an electromagnetic induction phenomenon.

In particular, the transformer unit 250 may be miniaturized and lightened by IGBT power conversion of 20 KHz or more, may be reduced to ¼ of the weight of the conventional welding machines, may be reduced to ⅓ of the size, and may be more easily handled or moved.

Further, the transformer unit 250 uses an isolation transformer in order to electrically isolate the system and the output part from each other to secure the safety of the system and the user and to improve the output characteristics by appropriately lowering the output voltage, and the isolation transformer uses a high frequency of at least 20 KHz or more in order to secure mobility by reducing the volume and weight.

Therefore, the inverter transformer unit 250 may employ an insulation transformer having good high-frequency characteristics.

The transformer unit 250 is useful for high-frequency switching, and is advantageous in that the transformer has a higher saturated frequency than a core coil and is inversely proportional to the frequency when the transformer performs high-frequency switching, which greatly assists in energy saving, weight reduction, and noise reduction of the system.

The volume of the transformer unit 250 at the frequency of 20 KHz is reduced to 1/10 compared to 50 Hz.

105 The second rectifying unit 260 rectifies the alternating current output through the transformer unit 250 and converts the alternating current into a direct voltage, which may be implemented as a full-wave rectification bridge circuit having a known structure including four diodes.

The output terminal 270 is connected to the base material BM and the welding torch TC to transmit (+) and (−) outputs of the output that is converted into the direct current (DC) through the second rectifying unit 260, and welding is performed using the welding torch TC.

The control unit 280 controls the overall operation of the inverter-type current supply unit 200, monitors the supply of an abnormal current through a Hall sensor or the like, and controls cleaning control, crater current control, anti-explosion operation, and driving of a heat dissipation fan.

The control unit 280 proposed by the present invention is a one-chip microprocessor including the microprocessor 281 and has the following characteristics.

The microprocessor 281 has a CPU, a ROM, a RAM, and an I/O port integrated and built in the same chip.

The microprocessor 281 has a built-in PWM, A/D converter, and LCD controller, and is a one time programmable (OTP) type.

In this type, an internal ROM may be programmed so that the user may program, write, and use the ROM at any time as desired, and the ROM has a reduced instruction set code (RISC) structure.

That is, the execution and the patch are simultaneously performed, so that the execution speed is fast.

The Harvard structure is divided into a program memory and a data memory, and the data memory is integrally managed in a register file format, so that a data memory area may be used like a general-purpose register.

In addition, since the CMOS is used, the power consumption (5 V, 2 mA or less at 4 MHz) is very small, and the transfer characteristic is excellent. In addition, noise margin is large, a degree of integration is high, and impedance is large.

The microprocessor 281 may easily interface with an analog signal using an analog-to-digital (A/D) converter, a pulse width modulated (PWM) output device, or the like.

The microprocessor 281 is designed to be applicable to various types of systems when the control unit 280 is implemented.

That is, a module is disposed around the microprocessor 281 to facilitate addition and deletion of the module according to the system.

The microprocessor 281 and a current detection circuit are located in the center of the PCB, and a display unit, which is determined whether or not the microprocessor 281 and the current detection circuit are to be mounted according to the system, is located at an edge thereof, and an insulation unit is located at a lower end of the entire circuit and is designed to maintain a distance from other modules.

The control unit 280 is designed simply by connecting the same to the outside with a connector.

Therefore, in the present invention, the inverter unit 240 is developed by employing the IGBT having a high switching speed and a high withstand voltage, thereby contributing to energy saving and miniaturization.

The contents of the controller 282 are for the output current and voltage from the inverter unit 240 to follow the target output current and voltage.

A control method for the output current is derived based on proportional-integral (PI) control by feeding back the output current.

To this end, a relationship between the output current and the output signal of the microprocessor 281 is expressed by the Equations and used for programming the microprocessor 281.

In addition, the controller 282 is applied to the welding machine, and simulations and experiments are performed to prove the effectiveness thereof.

In the present invention, in order to model the inverter unit 240, a system identification method of statistically estimating a model from actual measurement data of input and output is used.

That is, the system is experimentally identified using the relationship between the control signal and the output current in the microprocessor 281.

FIG. 4 shows a relationship between an IGBT module driving signal (PWM) and the output current.

This is expressed by the following Equation:

$${i}_{out} = 225 {e}^{[ \frac{5}{{P}_{w}} ]} \qquad ( 1 )$$

where, iₒᵤₜ is an output current, e is a natural constant or Euler's number, and

P_{w} is a PWM duty ratio (%) of an IGBT driving signal, 0≤P_{w}≤0.4.

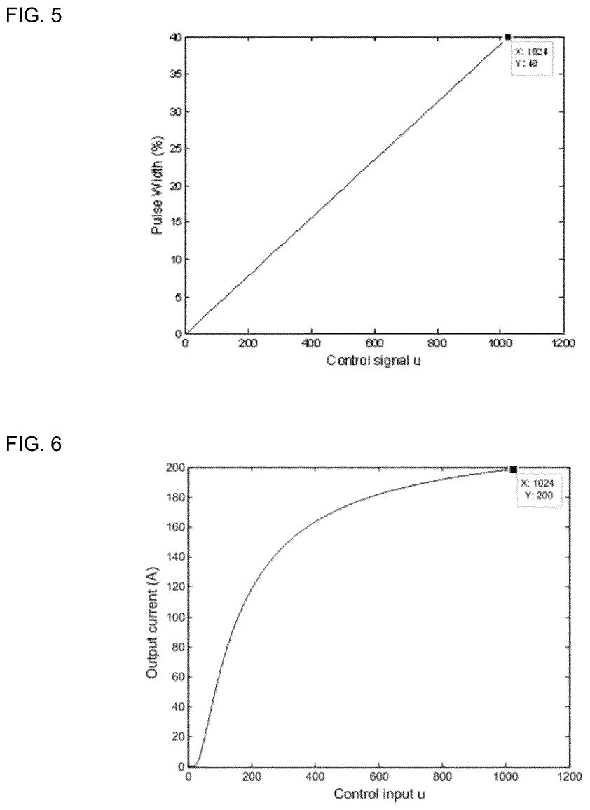

FIG. 5 shows a relationship between an IGBT driving signal (PWM) and the control current.

The driving signal of the IGBT of 40% is divided by the 10 Bits and controlled.

This is expressed by the following Equation:

$${P}_{w} = \frac{1}{25.6} u \qquad ( 2 )$$

where, u is a control signal.

By using Equations (1) and (2), the relationship between the control input signal and the output current may be derived.

This is expressed by the following Equation:

$${i}_{out} = 225 {e}^{( \frac{- 128}{u} )} \qquad ( 3 )$$

where, iₒᵤₜ is an output current.

FIG. 6 is a graph representing Equation (3).

From Equations (1) to (3), the relationship between the control signal input and the welding output current is derived.

In other words, the relationship between an input and an output is expressed by the Equations, which will be applied to the controller.

In the proportional controller 282, the tracking error ε is defined as follows:

ε=i_{ref}−iₒᵤₜ (4)
where, i_{ref} is a target output current, and corresponds to a target output current when hot-start and anti-stuck functions are performed.

That is, i_{ref} is a target current to be followed by the inverter unit 240.

The proportional (PI) controller 282 is expressed as follows:

$$u = {K}_{p} ε + {K}_{I} ( \frac{1}{{T}_{i}} {\int }_{0}^{{T}_{i}} ε dt ) \qquad ( 5 )$$

Tᵢ: Integration time sec of controller,
Kₚ: Proportional gain of controller A⁻¹, and
K_{I}: Integral gain of controller A⁻¹.

A tracking error of a discrete time is defined as follows:

εᵢ=i_{ref(i)}−iₒᵤₜ(i) (6)
i_{ref(i)}: Target current (i-th sampling time)
iₒᵤₜ₍ᵢ₎: Output current (i-th sampling time)

In the discrete time domain, Equation (5) may be expressed as follows:

uᵢ=Kₚeᵢ+D(i) (7)
uᵢ: Control signal (i-th sampling time)
εᵢ: Tracking error (i-th sampling time)
t_{d}: Sampling time
where, the sample time t_{d} is 15×10⁻⁶ sec.

When t->∞, the controller design is completed only when the proportional gain and the integral gain of the controller are set to be ε->0.

The proportional gain Kₚ and the integral gain K_{I} are stable when Kₚ=0.7 and K_{I}=115.

In Equation (7), D(i) is as follows:

$$D ( i ) = D ( i - 1 ) + \frac{{K}_{I} \times {t}_{d}}{2} ( {ε}_{i - 1} + {ε}_{j} ) \qquad ( 8 )$$

The PI controller 282 is applied as in a part of “A” in FIG. 2.

The inverter unit 240 proposed by the present invention controls the output current through the above-described PI control.

The output current is measured by using a signal output from the transformer unit 250, and the signal is compared with the set output current, so that the difference, that is, the tracking error, becomes zero (0).

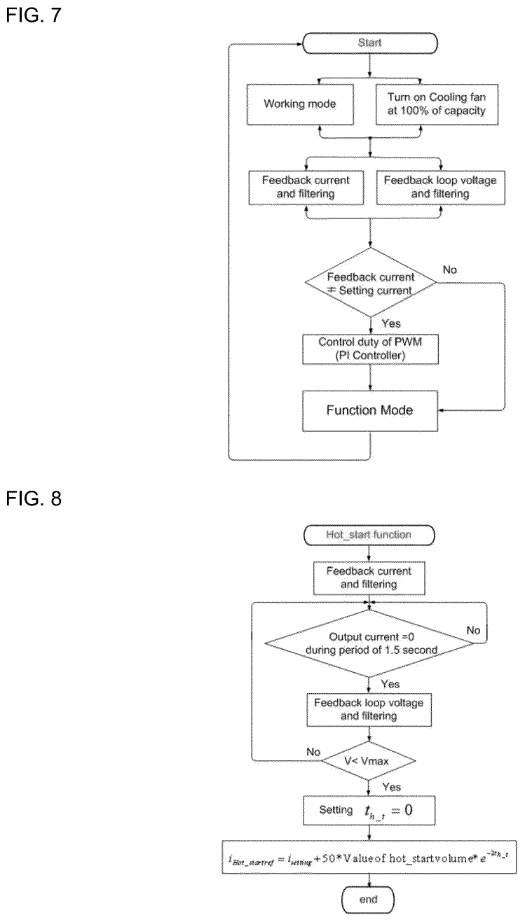

FIG. 7 is a flowchart showing an operation of the inverter unit 240.

When the inverter unit 240 is initially operated, a voltage and a current are measured, and when the measured current and voltage are different from the set values, the PI controller 282 is operated to follow the set current and voltage.

Next, the operation mode is changed to a function mode, in which a function required by each system is provided. Typically, in the case of the welding machine, the hot-stat function and the anti-stuck function are provided.

The welding output voltage changes according to the state of arc generated during welding.

As the arc length increases, the voltage also increases accordingly, and as the arc length decreases, the voltage decreases. When the arc length is excessively long, the arc may not be maintained and extinguished, so that welding may not proceed any longer.

176 Conversely, when the arc length is shortened, a phenomenon in which the welding rod and the base material are attached (stuck phenomenon) occurs.

177 The stuck phenomenon also prevents the welding from proceeding any further, and sometimes it is necessary to float the attached welding rod.

178 The welding state according to the welding output voltage is summarized in Table 1.

| state | voltage |
|---|---|
| Normal welding | 7~35 V |
| stuck (Vmin) | under 6 V |
| Arc disappear (Vmax) | over 36 V |

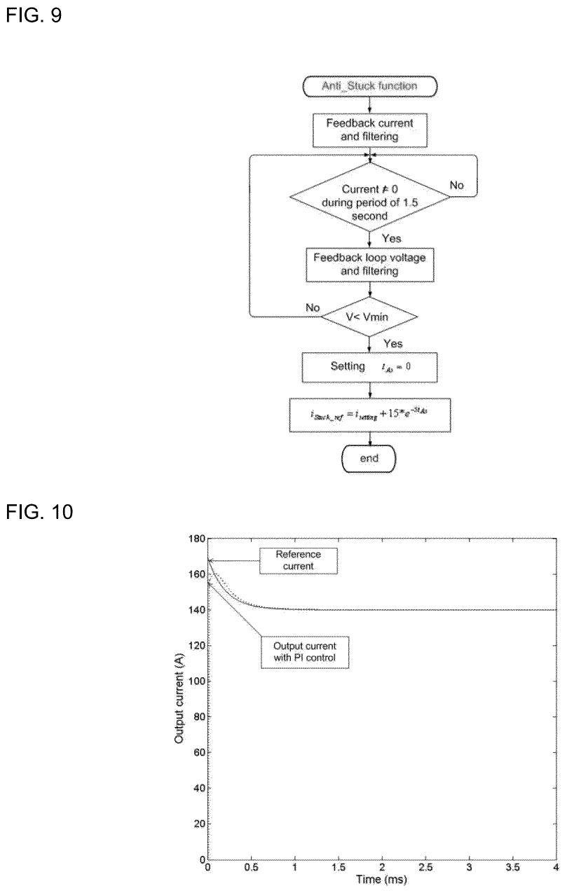

In the present invention, the hot-start function, the anti-stuck function, and the like are provided. A flowchart of the hot-start function and a flowchart of the anti-stuck function are shown in FIGS. 8 and 9.

FIG. 8 shows a flowchart of the hot-start function, which shows a function of instantaneously generating a current higher than the set welding output current by 0 to 50 amperes A according to the value of the hot-start control volume (%) so as to facilitate arc formation.

This is expressed by the following Equation:

i_{Hot_start ref}=i_{setting}+50×Value of hot_start volume×e^{-2t}^{_{h−t}} (9)
where, i_{Hot_start ref} is a target welding current provided with the hot-start function at the start of welding.
i_{setting} is a set welding current determined by the user.
tₕ₋ₜ means a time from a time when the hot-start function is performed.

FIG. 9 shows a flowchart of the anti-stuck function.

The anti-stuck function is a function developed such that when the voltage between the base material and the welding electrode drops to or below the reference voltage Vmin while measuring the voltage in real time while the welding is in progress, the welding output current is increased by 15 amperes A compared to the welding output current at the time when the welding output voltage drops, thereby allowing the welding electrode to prevent a short circuit with the base material and maintain the arc.

This is expressed by the following Equation:

i_{stuck_ref}=i_{setting}+15×(10)e^{t}^{_{As}}

where, i_{stuck_ref} is a target welding output current value applied from the moment when the welding operation drops to or below the reference voltage Vmin, that is, the moment when the anti-stuck function is performed.

The set welding output current is set to 140 amperes A, and the hot-start volume is set to 60%.

As shown in Table 1, the normal welding voltage is set to 36 V for Vmax and 6 V for Vmin.

FIG. 10 is a simulation result of the welding output current when the hot-start function of the inverter is performed by using the PI controller 282 proposed by the present invention.

With the realization of the hot-start function, it can be seen that the welding output current starts higher than the set welding output current by 20 amperes A at the start of welding.

It is shown that, up to 0.5 ms, the target welding output current increases by the hot-start function is followed, and from 1 ms, stable welding is achieved as the set welding output current is reached.

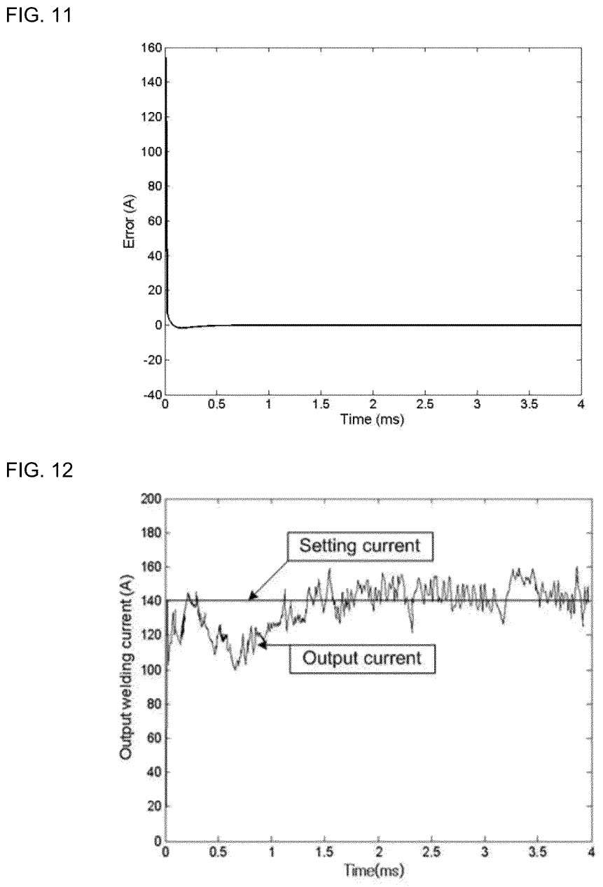

FIG. 11 shows a change in a control signal when the hot-start function is performed in a case where the PI controller 282 proposed by the present invention is used.

A large change in the control signal at the start of welding shows that the control signal is changed in order to generate a high current by the hot-start function.

It is shown that, from 0.5 ms, there is little change in the control input, and from 1 ms, the target control signal level is reached.

FIG. 12 shows a tracking error when the hot-start function is performed.

It can be seen that the large tracking error at the start of welding is based on the high welding output current when the hot-start function is performed, and the tracking error converges to zero (0) over time.

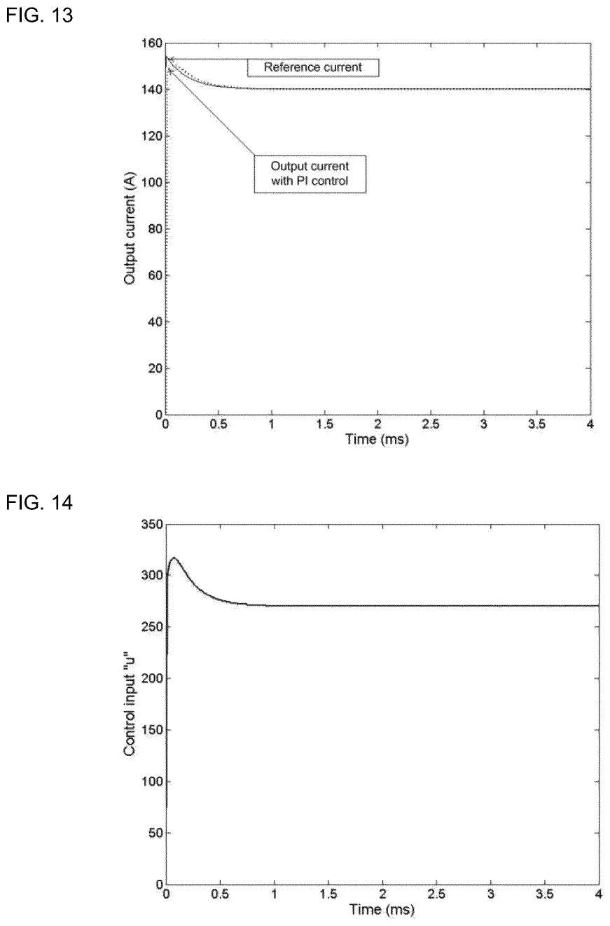

FIG. 13 is a simulation result of the welding output current when the anti-stuck function is performed by using the PI controller 282 of the present invention.

When the anti-stuck function is performed, the welding output current follows the target welding output current well and rapidly rises to 155 amperes A, thereby preventing the stuck phenomenon in which the welding rod is stuck to the base material. It is shown that, after 1 ms, since the output current for setting is followed well, stable welding is in progress.

FIG. 14 is a simulation result of a change in the control signal when the anti-stuck function is performed using the PI controller 282 of the present invention. It can be seen that a high control input is generated to operate the anti-stuck function at the initial stage of the operation of the anti-stuck function, and there is little change after the 0.5 ms like the hot-start function, and the control input is stabilized as the normal welding state is changed after 1 ms.

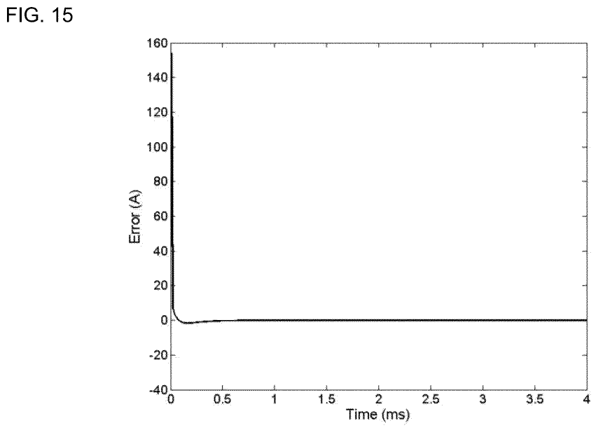

FIG. 15 shows a tracking error in a case where the anti-stuck function is performed when the PI controller 282 is applied. Initially, the tracking error is greatly increased because the welding output current is increased for the anti-stuck function, but it can be seen that the tracking error converges to zero (0) over time. Since the change is relatively smaller when the hot-start function is performed, it can be seen that the tracking error is smaller than when the hot-start function is performed.

As described above, the inverter-type proportional-control micro welding apparatus 100 according to the embodiments of the present invention may expect the following effects.

According to the present invention, one of the biggest advantages of the inverter welding machine is that the inverter welding machine is small and compact, is easy to carry, and may be carried like a lightweight briefcase.

In addition, since the inverter welding machine consumes less power and may operate at a normal household current (commercial current), maintenance costs are saved, thereby helping cost competitiveness.

In addition, since the output power of the inverter is electronically adjusted, the inverter welding machine has a wide power adjustment range of up to 100%, and thus the inverter welding machine may be finely adjusted to meet specific requirements, and the output may be stabilized, so that welding of uniform quality may be performed and welding defects may be reduced.

In addition, by applying a high-frequency inverter power circuit of the 20 kHz scale, there is an advantage in that the welding machine may be reduced in size and weight to about ⅓ to ½ of conventional products, while maintaining power consumption at approximately 60% to 70% of that of conventional comparable equipment.

In addition, a hot-start function is provided to facilitate arc generation when welding is started, thereby facilitating welding not only for experts but also for general users.

In addition, an anti-stuck function is implemented to prevent a short circuit between the base material and the welding rod that may occur during the welding process, thereby increasing the ease of work.

In addition, the inverter-type welding apparatus proposed in the present invention has the advantages of improving welding quality by controlling welding output current, reducing welding costs, and increasing welding productivity, thereby contributing to the welding industry a lot.

The above description illustrates the technical idea of the present invention, and it will be understood by those skilled in the art to which the present invention belongs that various modifications, changes, and substitutions may be made without departing from the scope of the essential characteristics of the present invention.

Therefore, the embodiments disclosed herein are to explain the present invention, rather than used to limit the technical spirit of the present invention, and the scope of the technical spirit of the present invention is not limited by those embodiments.

1. An inverter-type proportional-control micro welding apparatus comprising:
a main body;
a welding torch connected to the main body and provided therein with an electrode;
a welding electrode connected to the main body and connected to a material to be welded (BM); and
a current supply unit installed in the main body and configured to apply a current for welding to the electrode of the welding torch and the welding electrode,
wherein the current supply unit includes a power input unit connected to a commercial alternating current, a first rectifying unit configured to rectify the alternating current input from the power input unit into a direct current, a smoothing unit configured to smooth the direct current output from the first rectifying unit, an inverter unit configured to convert the direct current smoothed by the smoothing unit into a variable high-frequency alternating current, a transformer unit configured to transform the alternating current output from the inverter unit into a low-voltage high current suitable for welding, a second rectifying unit configured to re-rectify the alternating current output from the transformer unit to convert the rectified current into a direct current voltage, an output terminal connected to the electrode of the welding torch and the welding electrode to output a (+) output and a (−) output, and a control unit configured to control an overall operation of the current supply unit and perform hot-start and anti-stuck through a proportional controller.

2. The inverter-type proportional-control micro welding apparatus of claim 1, wherein the control unit derives an output current (iₒᵤₜ) in association with a control signal of a microprocessor through following Equations (1), (2), and (3).
$${i}_{out} = 225 {e}^{[ \frac{5}{{P}_{w}} ]} \qquad Equation ( 1 )$$
$${P}_{w} = \frac{1}{25.6} u \qquad Equation ( 2 )$$
$${i}_{out} = 225 {e}^{( \frac{- 128}{u} )} \qquad Equation ( 3 )$$
(where iₒᵤₜ is an output current, e is a natural constant, u is a control signal, and P_{w} is a PWM duty ratio (%), and 0≤P_{w}≤0.4)

3. The inverter-type proportional-control micro welding apparatus of claim 1, wherein, when a tracking error (ε) is i_{ref}−iₒᵤₜ, the proportional controller satisfies Equation
$$u = {K}_{p} ε + {K}_{I} ( \frac{1}{{T}_{i}} {\int }_{0}^{{T}_{i}} ε dt ) .$$
(where i_{ref} is a target current, iₒᵤₜ is an output current, u is a control signal, Ti is an integration time sec, Kₚ is a proportional gain A⁻¹, and Kr is an integral gain A⁻¹.)

4. The inverter-type proportional-control micro welding apparatus of claim 3, wherein the i_{ref} corresponds to a target current of the hot-start or anti-stuck.

5. The inverter-type proportional-control micro welding apparatus of claim 1, wherein the inverter unit measures a voltage and a current, and operates the proportional controller to follow a set current and a set voltage when the measured current and voltage are different from set values.

6. The inverter-type proportional-control micro welding apparatus of claim 1, wherein, in order to facilitate arc formation, when the control unit performs a hot-start function, following Equation is satisfied such that a current higher than a set welding output current by 0 to 50 A is instantaneously generated according to a value of a hot-start adjustment volume (%).
i_{Hot_start ref}=i_{setting}+50×Hot-start adjustment volume×e^{-2t}^{_{h−t}}
(where, i_{Hot_start ref} is a target welding current to which the hot-start function is provided at the time of starting welding, i_{setting} is a set welding current determined by a user, and tₕ₋ₜ is a time from a time when the hot-start function is performed.)

7. The inverter-type proportional-control micro welding apparatus of claim 1, wherein, when the control unit performs an anti-stuck function, following Equation is satisfied such that a voltage between the welding torch (120) and the material to be welded is measured in real time and a current is increased by 15 A compared to the welding output current at a time when the welding output voltage drops in case where the voltage drops to or below a reference voltage (Vmin).
i_{stuck_ref}=i_{setting}+15×e^{t}^{_{As}}
(where, i_{stuck_ref} is a target welding output current when the anti-stuck function is performed, and the set welding output current is 140 A.)
